(19) United States
(12) Patent Application Publication
(10) Pub. No.: US 2019/0176234 A1
(43) Pub. Date: Jun. 13, 2019

(54) TAILORED METAL POWDER FEEDSTOCKS FOR FACILITATING PREFERENTIAL RECOVERY AFTER ADDITIVE MANUFACTURING

(71) Applicant: ARCONIC INC., Pittsburgh, PA (US)

(72) Inventors: David W. Heard, Pittsburgh, PA (US); Deborah M. Wilhelmy, Greensburg, PA (US); Justen Schaefer, New Kensington, PA (US); William E. Boren, JR., Export, PA (US)

(21) Appl. No.: 16/274,990

(22) Filed: Feb. 13, 2019

Related U.S. Application Data
(63) Continuation of application No. PCT/US2017/047220, filed on Aug. 16, 2017.
(60) Provisional application No. 62/376,795, filed on Aug. 18, 2016.

(51) Int. Cl. B22F 3/105; B33Y 10/00; B33Y 40/00; B33Y 70/00

(52) U.S. Cl. CPC B22F 3/1055; B33Y 10/00; B22F 2003/1059; B33Y 70/00; B33Y 40/00

(57) ABSTRACT

Tailored metal powder feedstocks for additive manufacturing, and methods of recovering waste streams from the same are disclosed. One or more characteristics of the particles of the feedstock may be preselected, after which the tailored metal powder feedstock is produced. After the tailored metal powder feedstock is used in an additive manufacturing operation, a waste powder may be obtained and subjected to one or more predetermined powder recovery methodologies. At least partially due to the preselected particle characteristic(s), at least some of the first particles preferentially separate from at least some of the second particles during powder recovery.

### CROSS-REFERENCE TO RELATED APPLICATIONS

This application is a continuation of International Patent Application No. PCT/US2017/047220, filed Aug. 16, 2017, which claims the benefit of priority to U.S. Provisional Patent Application No. 62/376,795, filed Aug. 18, 2016, each of which is incorporated herein by reference in its entirety.

### BACKGROUND

Additive manufacturing is defined as “a process of joining materials to make objects from 3D model data, usually layer upon layer, as opposed to subtractive manufacturing methodologies.” ASTM F2792-12a entitled “Standard Terminology for Additively Manufacturing Technologies”. Powders may be used in some additive manufacturing techniques, such as binder jetting, powder bed fusion or directed energy deposition, to produce additively manufactured parts. Metal powders are sometimes used to produce metal-based additively manufactured parts.

### BRIEF DESCRIPTION OF THE FIGURES

FIG. 1 is a schematic view of one embodiment of a mechanical separation scheme for separating predetermined metal powder feedstocks.

FIG. 2 is a schematic view of one embodiment of another mechanical separation scheme for separating predetermined metal powder feedstocks.

FIG. 3 is a schematic view of one embodiment of an electromagnetic separation scheme for separating predetermined metal powder feedstocks.

### SUMMARY OF THE INVENTION

Broadly, the present disclosure relates to tailored metal powder feedstock for use in additive manufacturing, and corresponding preferential recovery of one or more types of particles of such metal powders. In one aspect, the tailored metal powder feedstock may include at least a first volume of a first particle type (“the first particles”) and a second volume of a second particle type (“the second particles”). The tailored metal powder feedstock may include additional types and volumes of particles (third volumes, fourth volumes, etc.). At least one of the first and second particles comprises metal particles having at least one metal therein. In one embodiment, both of the first and second particles comprise metal particles, and the metal of the particles may be the same or different relative to each of the volume of particles. At least one characteristic of the first particles is preselected, the selected characteristic of the first particles being different from a characteristic of the second particles. For instance, the dimension(s) and/or the physical properties of the particles of the first particles may be predetermined based on the powder recovery methodology to be employed. Thus, the selected particle characteristic(s) may relate to a predetermined powder recovery methodology. In one embodiment, one or more characteristics of the second particles are also preselected to facilitate their preferential recovery.

After the preselection of particle characteristic(s), a tailored metal powder feedstock comprising the first and second particles may be produced and subsequently utilized in an additive manufacturing process. After one or more additive manufacturing steps employing the tailored metal powder feedstock, waste portion of the metal powder may be obtained and subjected to one or more predetermined powder recovery methodologies. The waste portion may have a waste volume fraction of first particles (WP−V_{f}1P) and a waste volume fraction of second particles (WP−V_{f}2P). In one embodiment, a predetermined powder recovery methodology may produce a first recovered volume of particles. At least partially due to the preselected particle characteristic(s) of the first particles (and optionally the second particles), at least some of the first particles preferentially separate from at least some of the second particles during powder recovery. For instance, the predetermined powder recovery methodology may include mechanical separation (e.g., sieving, flotation, vibrational separation, filtration, centrifugation, among others), wherein particles of different size and/or shape are preferentially separated. The separation may be completed in wet and/or dry environments. Thus, the first recovered volume includes a first recovered volume fraction of first particles (RV1−V_{f}1P). Due to preferential separation, the first recovered volume fraction of first particles exceeds the waste volume fraction of first particles, (RV1−V_{f}1P)>(WP−V_{f}1P). Correspondingly, a second recovered volume may also be recovered, this second recovered volume including a recovered volume fraction of second particles (RV2−V_{f}2P). Due to preferential separation, the second recovered volume fraction of second particles exceeds the waste volume fraction of second particles, (RV2−V_{f}2P)>(WP−V_{f}2P).

### A. Predetermined Particle Characteristic(s)

As described above, one or more characteristics of the first and/or second volume of particles (and/or third volume, fourth volume, etc. of particles) may be preselected to facilitate separation of particles after the additive manufacturing process via one or more predetermined powder recovery methodologies. In one approach, the preselected characteristic is a dimensional characteristic, such as a size and/or shape of the particles. For instance, the first particles may have a first size (e.g., relatively large) and the second particles may have a different size (e.g., relatively small). Thus, during sieving, the first particles may preferentially separate from the second particles. As another example, the first particles may have a first shape (e.g., generally spherical) and the second particles may have a different shape (e.g., rectangular, jagged, oblong). In one embodiment, the first particles have a first particle size distribution and the second particles have a second particle size distribution, different than the first particle size distribution. In one embodiment, the first and second particle size distribution are only partially overlapping (e.g., overlap around D90-D99 and D10-D01 for the first and second particle size distributions, respectively). In one embodiment, the first and second particle size distribution are non-overlapping (e.g., no overlap between D90-D99 and D10-D01 for the first and second particle size distributions, respectively).

In another approach, the preselected characteristic is a physical property, such as density, magnetism or static charge. For instance, the first particles may have a first density (e.g., relatively heavy) and the second particles may have a different density (e.g., relatively light). Thus, during flotation, air classification, and/or a vibrational separation operation, the first particles may preferentially separate from the second particles. As another example, the first particles may have a first magnetic potential (e.g., relatively magnetic), and the second particles may have a second magnetic potential (e.g., relatively non-magnetic). Thus, during an electromagnetic separation operation, the first particles may preferentially separate from the second particles. As yet another example, the first particles may have a first surface charge (e.g., relatively positive), and the second particles may have a second surface charge (e.g., relatively negative). Thus, during an electrostatic separation, the first particles may preferentially separate from the second particles.

### B. Particles of the Tailored Metal Powder Feedstock

As described above, the tailored metal powder feedstock may include at least first particles and second particles. The tailored metal powder feedstock may also include additional types and volumes of particles (third volumes, fourth volumes, etc.). At least one of the first and second particles comprises metal particles having at least one metal therein.

As used herein, “metal powder” means a material comprising a plurality of metal particles, optionally with some non-metal particles, described below. The metal particles of the metal powder may have pre-selected physical properties and/or pre-selected composition(s), thereby facilitating production of tailored additively manufactured products. The metal powders may be used in a metal powder bed to produce a tailored product via additive manufacturing. Similarly, any non-metal particles of the metal powder may have pre-selected physical properties and/or pre-selected composition(s), thereby facilitating production of tailored additively manufactured products by additive manufacturing. The non-metal powders may be used in a metal powder bed to produce a tailored product via additive manufacturing.

As used herein, “metal particle” means a particle comprising at least one metal. The metal particles may be one-metal particles, multiple metal particles, and metal-non-metal (M-NM) particles, as described below. The metal particles may be produced, as one example, via gas atomization.

As used herein, a “particle” means a minute fragment of matter having a size suitable for use in the powder of the powder bed (e.g., a size of from 5 microns to 100 microns). Particles may be produced, for example, via gas atomization.

For purposes of the present patent application, a “metal” is one of the following elements: aluminum (Al), silicon (Si), lithium (Li), any useful element of the alkaline earth metals, any useful element of the transition metals, any useful element of the post-transition metals, and any useful element of the rare earth elements.

As used herein, useful elements of the alkaline earth metals are beryllium (Be), magnesium (Mg), calcium (Ca), and strontium (Sr).

As used herein, useful elements of the transition metals are any of the metals shown in Table 1, below.

TABLE 1
Transition Metals

| | Group | | | | | | | | |
|---|---|---|---|---|---|---|---|---|---|
| | 4 | 5 | 6 | 7 | 8 | 9 | 10 | 11 | 12 |
| Period 4 | Ti | V | Cr | Mn | Fe | Co | Ni | Cu | Zn |
| Period 5 | Zr | Nb | Mo | | Ru | Rh | Pd | Ag | |
| Period 6 | Hf | Ta | W | Re | | | Pt | Au | |

As used herein, useful elements of the post-transition metals are any of the metals shown in Table 2, below.

TABLE 2
Post-Transition Metals

| Group | 13 | 14 | 15 |
|---|---|---|---|
| Period 4 | Ga | Ge | |
| Period 5 | In | Sn | |
| Period 6 | | Pb | Bi |

As used herein, useful elements of the rare earth elements are scandium, yttrium and any of the fifteen lanthanides elements. The lanthanides are the fifteen metallic chemical elements with atomic numbers 57 through 71, from lanthanum through lutetium.

As used herein non-metal particles are particles essentially free of metals. As used herein “essentially free of metals” means that the particles do not include any metals, except as an impurity. Non-metal particles include, for example, boron nitride (BN) and boron carbide (BC) particles, carbon-based polymer particles (e.g., short or long chained hydrocarbons (branched or unbranched)), carbon nanotube particles, and graphene particles, among others. The non-metal materials may also be in non-particulate form to assist in production or finalization of the additively manufactured product.

In one embodiment, at least some of the metal particles consist essentially of a single metal (“one-metal particles”). The one-metal particles may consist essentially of any one metal useful in producing a product, such as any of the metals defined above. In one embodiment, a one-metal particle consists essentially of aluminum. In one embodiment, a one-metal particle consists essentially of copper. In one embodiment, a one-metal particle consists essentially of manganese. In one embodiment, a one-metal particle consists essentially of silicon. In one embodiment, a one-metal particle consists essentially of magnesium. In one embodiment, a one-metal particle consists essentially of zinc. In one embodiment, a one-metal particle consists essentially of iron. In one embodiment, a one-metal particle consists essentially of titanium. In one embodiment, a one-metal particle consists essentially of zirconium. In one embodiment, a one-metal particle consists essentially of chromium. In one embodiment, a one-metal particle consists essentially of nickel. In one embodiment, a one-metal particle consists essentially of tin. In one embodiment, a one-metal particle consists essentially of silver. In one embodiment, a one-metal particle consists essentially of vanadium. In one embodiment, a one-metal particle consists essentially of a rare earth element.

In another embodiment, at least some of the metal particles include multiple metals (“multiple-metal particles”). For instance, a multiple-metal particle may comprise two or more of any of the metals listed in the definition of metals, above. In one embodiment, a multiple-metal particle consists essentially of an aluminum alloy. In another embodiment, a multiple-metal particle consists essentially of a titanium alloy. In another embodiment, a multiple-metal particle consists essentially of a nickel alloy. In another embodiment, a multiple-metal particle consists essentially of a cobalt alloy. In another embodiment, a multiple-metal particle consists essentially of a chromium alloy. In another embodiment, a multiple-metal particle consists essentially of a steel.

In one embodiment, at least some of the metal particles of the metal powder are metal-nonmetal (M-NM) particles. Metal-nonmetal (M-NM) particles include at least one metal with at least one non-metal. Examples of non-metal elements include oxygen, carbon, nitrogen and boron. Examples of M-NM particles include metal oxide particles (e.g., Al₂O₃), metal carbide particles (e.g., TiC), metal nitride particles (e.g., Si₃N₄), metal borides (e.g., TiB₂), and combinations thereof.

The metal particles and/or the non-metal particles of the tailored metal powder feedstock may have tailored physical properties. For example, the particle size, the particle size distribution of the powder, and/or the shape of the particles may be pre-selected. In one embodiment, one or more physical properties of at least some of the particles are tailored in order to control at least one of the density (e.g., bulk density and/or tap density), the flowability of the metal powder, and/or the percent void volume of the metal powder bed (e.g., the percent porosity of the metal powder bed). For example, by adjusting the particle size distribution of the particles, voids in the powder bed may be restricted, thereby decreasing the percent void volume of the powder bed. In turn, additively manufactured products having an actual density close to the theoretical density may be produced. In this regard, the metal powder may comprise a blend of powders having different size distributions. For example, the metal powder may comprise a blend of the first particles having a first particle size distribution and the second particles having a second particle size distribution, wherein the first and second particle size distributions are different. The metal powder may further comprise a third particles having a third particle size distribution, a fourth particles having a fourth particle size distribution, and so on. Thus, size distribution characteristics such as median particle size, average particle size, and standard deviation of particle size, among others, may be tailored via the blending of different metal powders having different particle size distributions.

In one embodiment, a final additively manufactured product realizes a density within 98% of the product's theoretical density. In another embodiment, a final additively manufactured product realizes a density within 98.5% of the product's theoretical density. In yet another embodiment, a final additively manufactured product realizes a density within 99.0% of the product's theoretical density. In another embodiment, a final additively manufactured product realizes a density within 99.5% of the product's theoretical density. In yet another embodiment, a final additively manufactured product realizes a density within 99.7%, or higher, of the product's theoretical density.

The tailored metal powder feedstock may comprise any combination of one-metal particles, multiple-metal particles, M-NM particles and/or non-metal particles to produce the additively manufactured product, and, optionally, with any pre-selected physical property. For example, the metal powder may comprise a blend of a first type of metal particle with a second type of particle (metal or non-metal), wherein the first type of metal particle is a different type than the second type (compositionally different, physically different or both). The metal powder may further comprise a third type of particle (metal or non-metal), a fourth type of particle (metal or non-metal), and so on. The metal powder may be the same metal powder throughout the additive manufacturing of the additively manufactured product, or the metal powder may be varied during the additive manufacturing process.

### C. Additive Manufacturing

As described above, the tailored metal powder feedstocks are used in at least one additive manufacturing operation. As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. The additively manufactured products described herein may be manufactured via any appropriate additive manufacturing technique described in this ASTM standard that utilizes particles, such as binder jetting, directed energy deposition, material jetting, or powder bed fusion, among others.

In one embodiment, a metal powder bed is used to create an additively manufactured product (e.g., a tailored additively manufactured product). As used herein a “metal powder bed” means a bed comprising a metal powder. During additive manufacturing, particles of different compositions may melt (e.g., rapidly melt) and then solidify (e.g., in the absence of homogenous mixing). Thus, additively manufactured products having a homogenous or non-homogeneous microstructure may be produced.

After one or more additive manufacturing steps employing the tailored metal powder feedstock, waste powder may be obtained and subjected to a predetermined powder recovery methodology. For instance, during binder jetting only a portion of the feedstock will be used to produce the additively manufactured part. At least some of the unused portion of the feedstock may be recovered in the form of a waste powder stock for subsequent recovery, as described below.

### D. Powder Recovery

As described above, the metal powder feedstock is tailored to facilitate separation of at least the first particles from the second particles after an additive manufacturing step via one or more predetermined powder recovery methodologies. A predetermined powder recovery methodology may be any suitable methodology and apparatus for preferentially separating different particles of the waste powder. In one embodiment, the predetermined powder recovery methodology includes mechanical separation, such as sieving, flotation, air classification, vibrational separation, filtration and/or centrifugation, among others. The separation may be completed in wet and/or dry environments. In another embodiment, the predetermined powder recovery methodology includes electromagnetic and/or electrostatic separation.

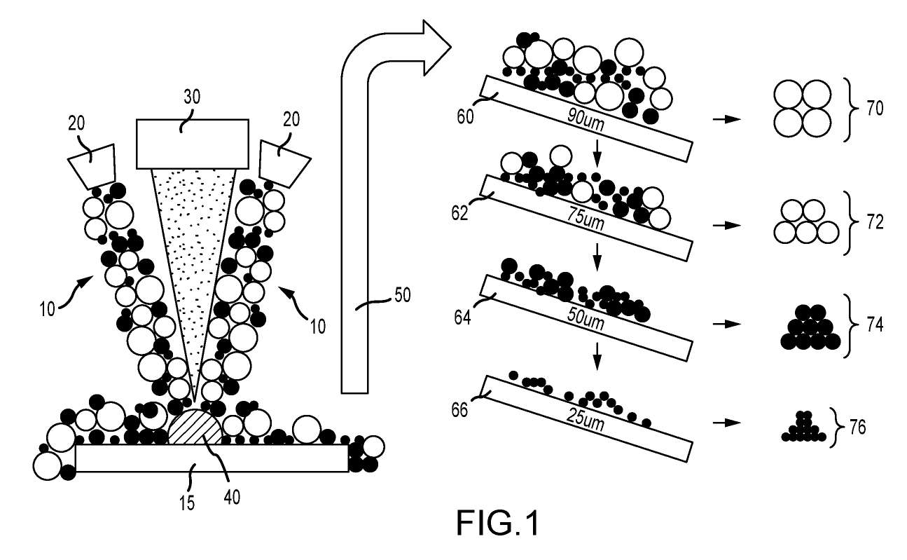

One of a mechanical separation scheme is illustrated in FIG. 1. In the illustrated embodiment, a metal powder feedstock (10) having predetermined particle sizes is provided to a substrate (15) via nozzles (20). A laser (30) and corresponding control system (not shown) is used to produce an additively manufactured part (40) from the metal powder feedstock (10). Waste powder (50) comprising a portion of the metal powder feedstock (10) is provided to sieves (60, 62, 64, 66). The apertures (not shown) of the sieves (60, 62, 64, 66) may correspond to the predetermined particle sizes of the metal powder feedstock (10). In turn, and due to at least the predetermined particle sizes of the metal powder feed stock (10), the particles of the metal powder feedstock (10) are separable into tailored recovered particle streams (70, 72, 74, 76) via the apertures of the sieves (60, 62, 64, 66). It is to be appreciated that the sizes illustrated on the sieves (90 um, 75 um, 50 um, and 25 um) are merely non-limiting example sieve sizes to illustrate the scheme; any appropriate sieve size(s) may be used in practice.

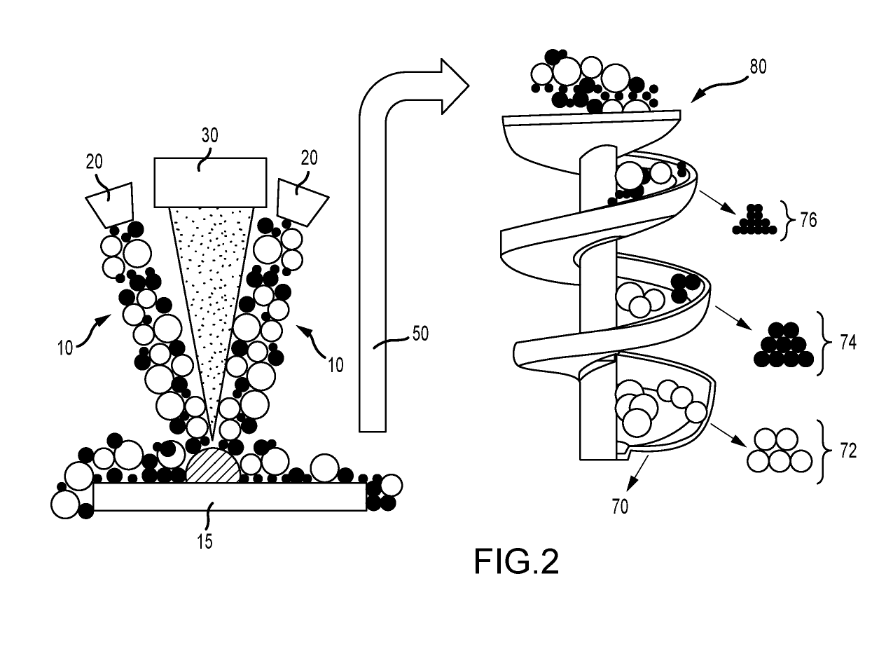

Another mechanical separation scheme is illustrated in FIG. 2, using a spiral separator (80). In the illustrated embodiment, a metal powder feedstock (10) having predetermined particle densities is provided to a substrate (15) via nozzles (20). A laser (30) and corresponding control system (not shown) is used to produce an additively manufactured part (40) from the metal powder feedstock (10). In the embodiment of FIG. 2, waste powder (50) comprising a portion of the metal powder feedstock (10) is provided to the spiral separator (80). Due to at least the predetermined particle densities, the particles of the metal powder feedstock (10) are separable into tailored recovered particle streams (70, 72, 74, 76) via the spiral separator (80).

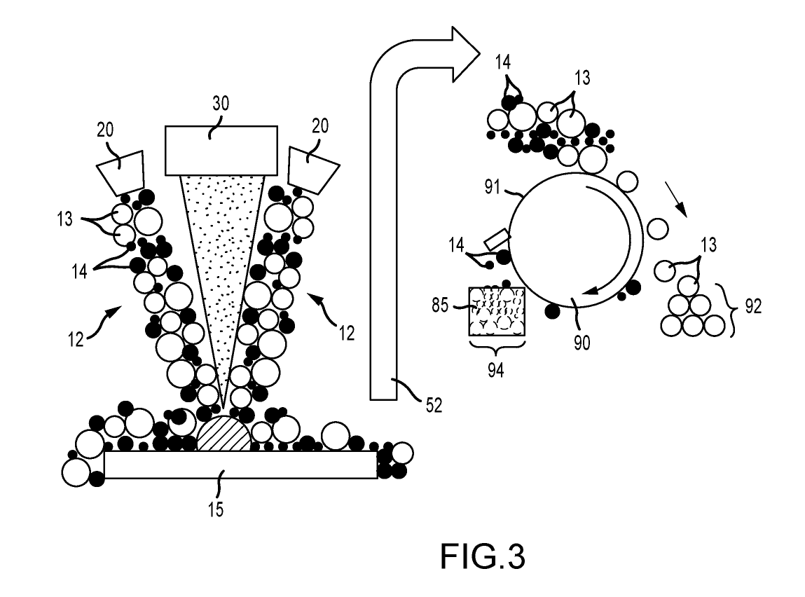

One embodiment of an electromagnetic separation scheme is illustrated in FIG. 3. In the illustrated embodiment, a metal powder feedstock (12) having predetermined magnetic properties is provided to a substrate (15) via nozzles (20). Specifically, at least first particles (13) have a first predetermined magnetic property (e.g., relatively non-magnetic) and at least second particles (14) have a second predetermined magnetic property (e.g., relatively magnetic). A laser (30) and corresponding control system (not shown) is used to produce an additively manufactured part (40) from the metal powder feedstock (12). In the embodiment of FIG. 3, waste powder (52) is provided to electromagnetic separator (90), where the second particles (14) are attracted to the electromagnetic separator (90), and, therefore, attach to an outer surface (91) of the electromagnetic separator (90). The first particles (13), being relatively non-magnetic, do not attach to the outer surface (91), and, upon rotation of the electromagnetic separator (90), separate from the second particles (14), e.g., due to gravity, thereby making a first recovered particle stream (92). The second particles (14) may be removed from the outer surface (91), such as via mechanical scraper (85), thereby forming a second recovered particle stream (94).

While various embodiments of the new technology described herein have been described in detail, it is apparent that modifications and adaptations of those embodiments will occur to those skilled in the art. However, it is to be expressly understood that such modifications and adaptations are within the spirit and scope of the presently disclosed technology.

What is claimed is:

1. A method comprising:
selecting at least one first particle characteristic for first particles of a metal powder, wherein the metal powder comprises the first particles and second particles;
wherein the first particle characteristic is different than one or more particle characteristics of the second particles; and
wherein the first particle characteristic relates to a predetermined powder recovery methodology; and
wherein at least one of the first and second particles comprises a metal;
producing the metal powder having the first and second particles, the first particles having the at least one first particle characteristic;
utilizing the metal powder in an additive manufacturing apparatus to produce an additively manufactured product;
in conjunction with the utilizing step, obtaining a waste portion of the metal powder, the waste portion having a waste volume fraction of first particles (WP−V_{f}1P); and
subjecting the waste portion to the predetermined powder recovery methodology, wherein the subjecting step comprises preferentially separating, due to the at least one first particle characteristic, at least some of the first particles from at least some of the second particles of the waste portion, thereby producing a first recovered volume having a first recovered volume fraction of first particles (RV1−V_{f}1P);
wherein the first recovered volume fraction of first particles exceeds the waste volume fraction of first particles, (RV1−V_{f}1P)>(WP−V_{f}1P).

2. The method of claim 1, wherein the waste portion comprises a waste volume fraction of second particles (WP−V_{f}2P), the method comprising:
recovering a second recovered volume from the waste portion;
wherein the second recovered volume includes a recovered volume fraction of second particles (RV2−V_{f}2P); and
wherein the recovered volume fraction of second particles exceeds the waste volume fraction of seconds particles, (RV2−V_{f}2P)>(WP−V_{f}2P).

3. The method of claim 1, wherein the first particle characteristic is at least one of a dimensional characteristic and a physical property characteristic of the first particles.

4. The method of claim 3, wherein the dimension characteristic is at least one of a shape and a size of the first particles.

5. The method of claim 3, wherein the physical property characteristic is at least one of a magnetic, surface charge, and a density of the first particles.

6. The method of claim 1, wherein the predetermined powder recovery methodology comprises mechanical separation.

7. The method of claim 6, wherein the mechanical separation is at least one of sieving, flotation, filtration, centrifugation, air classification, and vibrational separation.

8. The method of claim 1, wherein the predetermined powder recovery methodology is at least one of electromagnetic separation and electrostatic separation.

9. The method of claim 1, wherein the first particles have a first particle size distribution and the second particles have a second particle size distribution, different than the first particle size distribution.

10. The method of claim 9, wherein the first and second particle size distribution are partially overlapping.

11. The method of claim 10, wherein the selecting step comprises:
selecting the first particle size distribution as a first particle characteristic; and
wherein, the producing step comprises producing the producing the metal powder having the first particle size distribution.

12. The method of claim 11, wherein the selecting step comprises:
selecting the first particle size distribution as a second particle characteristic; and
wherein, the producing step comprises producing the producing the metal powder having the first particle size distribution and the second particle size distribution.

13. The method of claim 12, wherein the first particle size distribution relates to the first recovered volume fraction of first particles (RV1−V_{f}1P).

14. The method of claim 9, wherein the first and second particle size distribution are non-overlapping.

15. The method of claim 9, wherein, due to the first and second particle size distributions, the additively manufactured product realizes a density, wherein the density is within 98% of the theoretical density of the additively manufactured product.

15. The method of claim 9, wherein, due to the first and second particle size distributions, the additively manufactured product realizes a density, wherein the density is within 98% of the theoretical density of the additively manufactured product.

16. The method of claim 1, wherein the first particles are multiple-metal particles and wherein the second particles are metal-nonmetal particles.

17. The method of claim 17, wherein the multiple metal particles have a first particle size distribution, wherein the metal-nonmetal particles have a second particle size distribution, wherein the first and second particle size distributions are non-overlapping.
